(19) United States
(12) Patent Application Publication
(10) Pub. No.: US 2026/0292583 A1
(43) Pub. Date: Sep. 24, 2026

(54) DIFFERENTIATED SERVICES CODE POINT (DSCP) AS URSP TRAFFIC DESCRIPTOR

(71) Applicant: Telefonaktiebolaget LM Ericsson (publ), Stockholm (SE)

(72) Inventors: Jari Vikberg, Järna (SE); Jan Backman, Kärna (SE); Robert Skog, Hässelby (SE)

(21) Appl. No.: 19/477,547

(22) PCT Filed: Apr. 28, 2023
(86) PCT No.: PCT/EP2023/061287

§ 371 Date: Oct. 22, 2025

(51) Int. Cl. H04W 28/02; H04W 40/04; H04W 40/12

(52) U.S. Cl. CPC H04W 28/0263; H04W 40/04; H04W 40/12

(57) ABSTRACT

Enabling granular control of application flows with Differentiated Services Code Point (DSCP) identifiers with User Equipment Route Selection Policy (URSP) traffic classification in a wireless communications system. A UE or a Fixed Wireless Consumer Premises Equipment (FW CPE) can receive URSP rules from a core network node, where the URSP rules also include DSCP values as URSP traffic descriptors. Then, application flows that include DSCP values from the UE or from devices connected to the FW CPE can then be mapped to Protocol Data Unit (PDU) sessions established with a Communication Service Provider (CSP). The data can then be transmitted by the UE or FW CPE to the CSP via the PDU session selected based on the DSCP value.

### TECHNICAL FIELD

The present disclosure relates to enabling granular control of application flows with Differentiated Services Code Point (DSCP) identifiers with User Equipment Route Selection Policy (URSP) traffic classification in a wireless communications system.

### BACKGROUND

### 5G Background

Standardization work has been ongoing in Next Generation Radio Access Network (NG-RAN) and Fifth Generation (5G) Core network (5GC) as new radio access and new packet core network since Third Generation Partnership Project (3GPP) Rel-15 (see 3GPP Technical Specification (TS) 23.501 and 23.502 for stage-2 descriptions). FIG. 1 shows a 5G System architecture using service-based representation (corresponds to FIG. 4.2.3-1 from TS 23.501 V18.0.0).

FIG. 2 shows the internal architecture for a gNB 202 i.e., referring to a base station supporting New Radio (NR) Radio Access Technology (RAT) in the RAN of FIG. 1 and is referred to as a NG-RAN in this case (see 3GPP TS 38.401 for stage-2 description of NG-RAN). FIG. 2 assumes that both Higher Layer Split (HLS) and Control Plane 204 and User Plane 206 split (CP-UP split) have been adopted within the gNB 202.

### QoS Principle in 5GS

Quality of Service (QoS) is managed in a 5G wireless network, i.e., in a 5G System (5GS) on a per QoS flow level from the Core Network (CN). The NG-RAN (i.e., gNB or ng-eNB) is responsible for setting up the radio bearers for QoS Flows, radio resource management, and enforcing QoS according to the QoS Flow Profile—over the radio interface in the downlink and over the transport network in the uplink. QoS Flows are identified by a QoS Flow ID (QFI). QoS Flows including a QoS Profile are set up between the User Plane Function (UPF) in the 5GC and the user equipment device (UE).

5GS has defined a new term called a Protocol Data Unit (PDU) session that is very similar to a PDN connection in the earlier mobile generations. One difference is that there is normally only a single N3/NG-U tunnel (a GTP-U tunnel) for each PDU session between the UPF and NG-RAN. This means that the mapping of different traffic/QoS flows to radio bearers is performed in the NG-RAN, for example a radio bearer can carry one or more QoS Flows. A QoS Flow is the finest granularity of QoS differentiation in a PDU session. Each QoS Flow is associated with QoS parameters that are used to enforce the correct traffic forwarding treatment. Each packet belongs to a QoS Flow and one PDU session can carry one or several QoS Flows.

The QoS Flow level QoS Parameters can be either non-dynamic or dynamic. The Non-dynamic case is very similar to the QoS Class Identifier (QCI) concept in Evolved Packet System (EPS) but is called 5G QoS Identifier (5QI). The 5QI is a scalar that is a part of the 5G QoS parameters and it is used as a reference to standardized (i.e., pre-configured) 5G QoS characteristics that control QoS forwarding treatment for the QoS Flow (e.g., scheduling weights, admission thresholds, queue management thresholds, link layer protocol configuration, etc.), see TS 23.501 clause 5.7.2 and particularly clause 5.7.2.1. This means that the 5QI value as such is signaled from 5GC to NG-RAN and defines the main characteristics for the QoS Flow. The dynamic case is somewhat different as in this case actual 5G QoS characteristics are also signaled from 5GC to NG-RAN. These signaled characteristics may include Priority Level, Packet Delay Budget, Packet Error Rate, Delay Critical, Averaging Window and Maximum Data Burst Volume, see TS 23.501 clause 5.7.2.1 and particularly clause 5.7.3.

### Traffic Classification

Traffic classification is about how to map different applications and their corresponding application flows from a specific UE to different network resources (e.g., network slices, PDU sessions, QoS flows and Radio Bearers) in both uplink (UL) and downlink (DL). Such network resources may have separate 5G QoS parameters and characteristics associated to them. Network Initiated-Quality of Service (NI-QoS) and URSP are examples of traffic classification mechanisms with different control points. Traffic classification is an essential functionality for any QoS support in mobile networks. It is however important to understand that additional functionality is needed when networks are planned and deployed with QoS support in mind. Examples of additional functionality needed are Service Level Agreement (SLA) and SLA assurance support. Most applications use multiple application flows with different requirements. This puts demands on a mechanism to map individual application flows to the different network resources. In many cases, mapping at application-level will not be enough. An example of traffic classification, such as URSP, is depicted in FIG. 3, where a UE 302 communicates with an application provider 306 via a communication service provider (CSP) 304. The UE 302 may have one or more applications 308 that have different QoS flows 310-1, 310-2, 310-3 that have respective QoS levels.

### DSCP

Differentiated Services (DS) use a 6-bit differentiated services code point (DSCP) in the 8-bit differentiated services field (DS field) in the Internet Protocol (IP) header for packet classification purposes. The DS field replaces the outdated IPv4 Type of Service (TOS) field. In IPV6 case, the DSCP field is coded in the Traffic Class (TC) field.

In 3GPP DS is used to give different QoS treatment for packets with the same UE IP address and to do that, packet filters must be used to steer traffic into different QoS-classes (QCI/5QI).t

### Fixed Wireless Access

A Fixed Wireless Access (FWA) may have a Fixed Wireless Terminal (FWT) which can also be called a Customer Premises Equipment (CPE) or FWA device and Mobile Broadband Router (MBR). FWA is about providing an end user with fixed line services by utilizing a wireless technology, e.g., GSM, UMTS/HSPA/WCDMA, LTE/EPC, 5G, CDMA or WiMAX technologies. Fixed Wireless Terminals offer a cost efficient way to provide high speed data, voice and fax services to small office/home office and residential users.

FIG. 4 shows the main principle of FWA and FWT. The FWA device 410 is for example located in an end user's home or office 402, normally in the same location all the time (i.e., there is no real mobility related to the FW CPE itself except “nomadicity” i.e., that the FWT could be powered off in one place, moved to another location and then powered on again). The FWA device 410 provides both internet and local connectivity and services for end user equipment located in the home using for example WLAN/WiFi or Ethernet. Typical end user equipment are such devices as UE 416, Personal Computer (PC) 418, Fax machine 414, or network attached storage (NAS) device 412. In addition, the FWA device 410 may provide support for multiple legacy services. For example, a black phone (i.e., good old, fixed phone) can be connected to the FW CPE 410. The FWA device 410 is then directly connected to the mobile operator's radio access network 404 and core network 406 and can, for example, provide access towards the Internet 408.

### Solutions for URSP Traffic Categories

Traffic categories are needed to communicate QoS needs in a simple and generic way such as low latency and different levels of bandwidth requirements. Traffic categorization is therefore a variant of the traffic classification discussed above, i.e., all applications and application flows indicating the same traffic category would be classified to the same network resources.

URSP is standardized by 3GPP for a UE connected to multiple slices and/or PDU Sessions. The 3GPP standards define multiple different types of traffic descriptors such as DNN, domain, IP and application descriptors that would in principle allow both application and application flow level mapping to network resources (see 3GPP TS 23.503 chapter 6.6.2). Some device Operating System (OS) vendors have taken their own initiative on interpreting the App-ID field (i.e., the “Application descriptors” in table 6.6.2.1-2 of 3GPP TS 23.503) in the URSP rules. Instead of identifying an application, as actually defined in 3GPP TS 23.503, they put in a traffic category that the application could specify when setting up the communication. These traffic categories were not controlled by the operator, instead the operator is supposed to define a matching subscription and map to this with the aid of the traffic categories. Examples of such traffic categories are “Low Latency” and “High Bandwidth”. 3GPP Rel-18 contains work to standardize the traffic categories as part of Connection Capabilities (as defined in table 6.6.2.1-2 of 3GPP TS 23.503). Amongst others, this activity contains the classes “On demand downlink streaming” (mapping well to “High Bandwidth”), “Real time interactive traffic” (mapping well to “Reliability”) and “Critical communications” (that maps well to “Low Latency”). The following steps can be seen with reference to FIG. 5 for context:
1. URSP rules are sent to the UE 502 (i.e., UE modem 504) from the Policy Control Function (PCF) 514 in the core network 516.
   a) As an example the URSP rules contain the following 3 rules:
      Default/Best Effort: when no other rules match, pointing to the DNN Selection field in the Route Selection component with the value: “Internet PDU Session, best effort”
      Low Latency: URSP Traffic Category “LOW LATENCY”, pointing to the DNN Selection field in the Route Selection component with the value: “Internet PDU Session, low latency”
      Background: URSP Traffic Category “BACKGROUND”, pointing to the DNN Selection field in the Route Selection component with the value: “Internet PDU Session, background”
2. URSP rules are read into the URSP rule cache 506 in the Operating System (OS) 510 of the UE 502.
3. App Client-X 508 is requesting a socket and indicates also a specific Traffic Category.
   a) As an example, the indicated Traffic Category is “LOW LATENCY”.
4. OS 510 parses the URSP rules in the URSP rule cache 506.
5. OS 510 requests the modem to create the relevant PDU session for the requested Traffic Category based on the parsed URSP rules (if needed i.e., when that PDU Session is not already established).
   a) Note that in FIG. 5, 3 different PDU sessions (512-1, 512-2, and 512-3) are already shown as established.
   b) As an example, the relevant PDU session is “Internet PDU Session, low latency” 512-2.
6. The socket requested by App Client-X 508 is bound to the source IP for the PDU Session associated with the requested Traffic Category and the socket is ready for use.

There currently exist certain challenge(s). Currently known URSP solutions are limited when it comes to supporting Fixed Wireless Access. In these cases, the remote applications are located on a remote UE that is further connected to the mobile network via a FWA device. These remote applications create multiple application flows with different characteristics and requirements. There is no standard way of mapping application QoS requirements today to support the mapping of these flows to the network resources by URSP rules defined by the CSPs. URSP Traffic Categories can be indicated by the remote applications in the remote UE but there is no way to forward this information to the FWA device where the URSP rules are handled.

### SUMMARY

The present disclosure provides for enabling granular control of application flows with Differentiated Services Code Point (DSCP) identifiers with User Equipment UE) Route Selection Policy (URSP) traffic classification in a wireless communications system. A Fixed Wireless Access device or a UE can receive URSP rules from a core network node, where the URSP rules also include DSCP values as URSP traffic descriptors. Then, application flows that include DSCP values from the UE or from devices connected to the FWA device or Fixed Wireless Consumer Premise Equipment (FW CPE) can then be mapped to Protocol Data Unit (PDU) sessions established with a Communication Service Provider (CSP). The data can then be transmitted by the UE or FW CPE to the CSP via the PDU session selected based on the DSCP value.

In an embodiment, a method can be performed by a device for enabling granular control of application flows with DSCP identifiers with URSP traffic classification. The method can include receiving a URSP rule that comprise DSCP values as URSP traffic descriptors. The method can also include receiving an indication of a new application flow associated with an application, wherein the indication of the application flow comprises a DSCP value. The method can also include determining a Protocol Data Unit, PDU, session based on the URSP rule that comprises the DSCP value comprised in the indication of the new application flow. The method can also include transmitting data for the new application flow via the PDU session that is determined based on the URSP rule that comprises the DSCP value and a corresponding URSP traffic descriptor.

In an embodiment, the method can further include determining that the PDU session is not established and establishing the PDU session.

In an embodiment, the method can further include receiving the URSP rule from a core network node.

In an embodiment, the is a UE, and the application is a local application. In another embodiment, the indication of the new application flow is a socket request. In another embodiment the socket request comprises the DSCP value, or a socket option setting associated with the socket request comprises the DSCP value. In another embodiment, the socket request is bound to a source Internet Protocol, IP, address of the PDU session.

In an embodiment, the device is a FWA device, and the application is a remote application on a UE communicably coupled to the FWA device. In an embodiment, the indication of the new application flow is a received packet on a network connection with the UE. In an embodiment, the received packet comprises the DSCP value. In an embodiment, the new application flow is bound to a source IP of the PDU session.

In another embodiment, the method can include receiving another indication of a new application flow from the application, the other indication of a new application flow comprising a different DSCP value, determining another PDU session based on another URSP traffic descriptor corresponding to the other DSCP value, and transmitting other data from the other application via the other PDU session.

In an embodiment, the PDU session corresponds to a URSP traffic category of at least one of the following URSP traffic categories a background traffic category; a default traffic category; a high bandwidth traffic category; a medium bandwidth traffic category; a bounded medium latency traffic category; or a time-critical traffic category.

In an embodiment, a device configured for enabling granular control of application flows with DSCP identifiers with URSP traffic classification can include a radio interface and processing circuitry to receive a URSP rule that comprise DSCP values as URSP traffic descriptors. The processing circuitry can also receive an indication of a new application flow with an application, wherein the indication of the application flow comprises a DSCP value. The processing circuitry can also determine a Protocol Data Unit, PDU, session based on the URSP rule that comprises the DSCP value comprised in the indication of the new application flow. The processing circuitry can also transmit data for the new application flow via the PDU session that is determined based on the URSP rule that comprises the DSCP value and a corresponding URSP traffic descriptor.

In an embodiment, a non-transitory computer-readable medium can be provided that comprises instructions stored thereon, that when implemented by a processor perform operations for enabling granular control of application flows with DSCP identifiers with URSP traffic classification. The operations can include receiving a URSP rule that comprise DSCP values as URSP traffic descriptors. The operations can also include receiving an indication of a new application flow with an application, wherein the indication of the application flow comprises a DSCP value. The operations can also include determining a Protocol Data Unit, PDU, session based on the URSP rule that comprises the DSCP value comprised in the indication of the new application flow. The operations can also include transmitting data for the new application flow via the PDU session that is determined based on the URSP rule that comprises the DSCP value and a corresponding URSP traffic descriptor.

Some of the advantages provided by the techniques disclosed herein is the added support for the Fixed Wireless Access (FWA) use case. In addition, the solution also gives better control for the CSP operator to steer the match between DSCP values and URSP rules. Furthermore, another advantage is providing the same solution for applications both local and remote.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a Fifth Generation (5G) system architecture;

FIG. 2 illustrates an example of a Next Generation Radio Access Network (NG-RAN) architecture;

FIG. 3 illustrates an example of traffic classification;

FIG. 4 illustrates an example of a Fixed Wireless Area (FWA) served by a Fixed Wireless Consumer Premises Equipment (FW CPE) device connected to a Communications Service Provider (CSP);

FIG. 5 illustrates an example of User Equipment Route Selection Policy (URSP) traffic categorization;

FIG. 6 illustrates an example of a URSP solution that enables granular control of application flows of with Differentiated Services Code Point (DSCP) identifiers with a UE or FW CPE according to some embodiments of the present disclosure;

FIG. 7 illustrates a message sequence chart for a URSP solution that enables granular control of application flows of with Differentiated Services Code Point (DSCP) identifiers according to some embodiments of the present disclosure;

FIG. 8 illustrates one example of a cellular communications system in which embodiments of the present disclosure may be implemented;

FIG. 9 is a schematic block diagram of a wireless communication device according to some embodiments of the present disclosure; and

FIG. 10 is a schematic block diagram of the wireless communication device according to some other embodiments of the present disclosure.

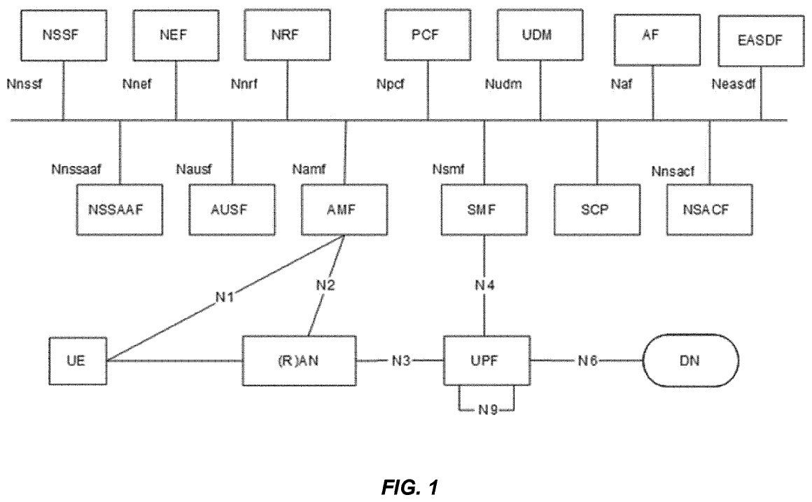

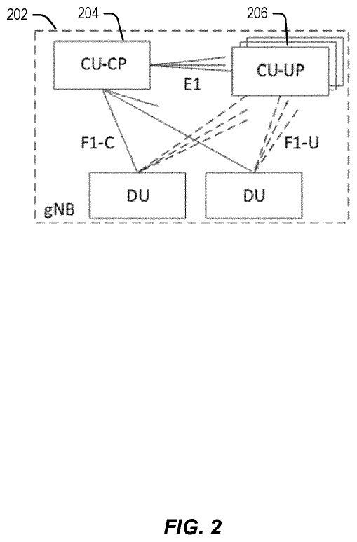

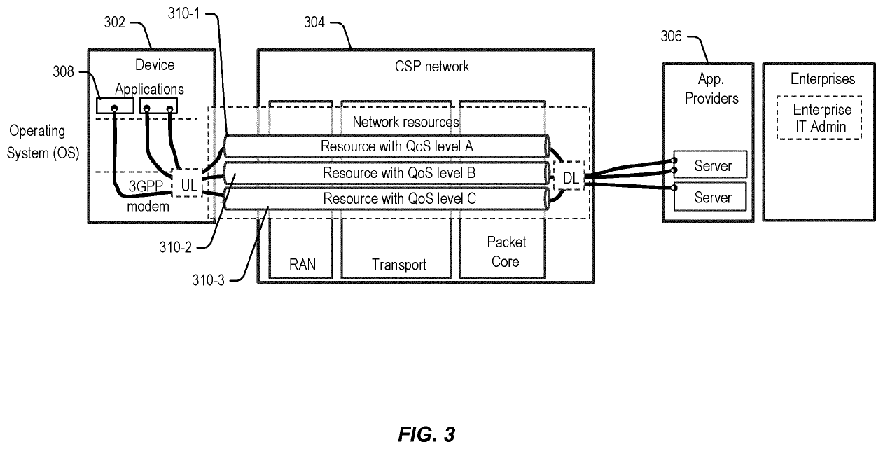

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure

Function (NEF), a Network Function (NF) Repository Function (NRF), a Policy Control Function (PCF), a Unified Data Management (UDM), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure provides for enabling granular control of application flows with Differentiated Services Code Point (DSCP) identifiers with User Equipment (UE) Route Selection Policy (URSP) traffic classification in a wireless communications system. A UE or a Fixed Wireless Consumer Premises Equipment (FW CPE) can receive URSP rules from a core network node, where the URSP rules also include DSCP values as URSP traffic descriptors. Then, application flows that include DSCP values from the UE or from devices connected to the FW CPE can then be mapped to Protocol Data Unit (PDU) sessions established with a Communication Service Provider (CSP). The data can then be transmitted by the UE or FW CPE to the CSP via the PDU session selected based on the DSCP value.

The present disclosure provides a technique and method for identifying DSCP values in the UE and uses these as keys in URSP rule matching. For this to be possible DSCP specific URSP rules can be created. By using DSCP traffic marking as a URSP Traffic Descriptors, the present disclosure supports both local applications on a UE connected to the CSP network, and remote applications on a UE connected to the CSP network via a FWA CPE.

Some of the advantages provided by the techniques disclosed herein is the added support for the Fixed Wireless Access (FWA) use case. In addition, the solution also gives better control for the CSP operator to steer the match between DSCP values and URSP rules.

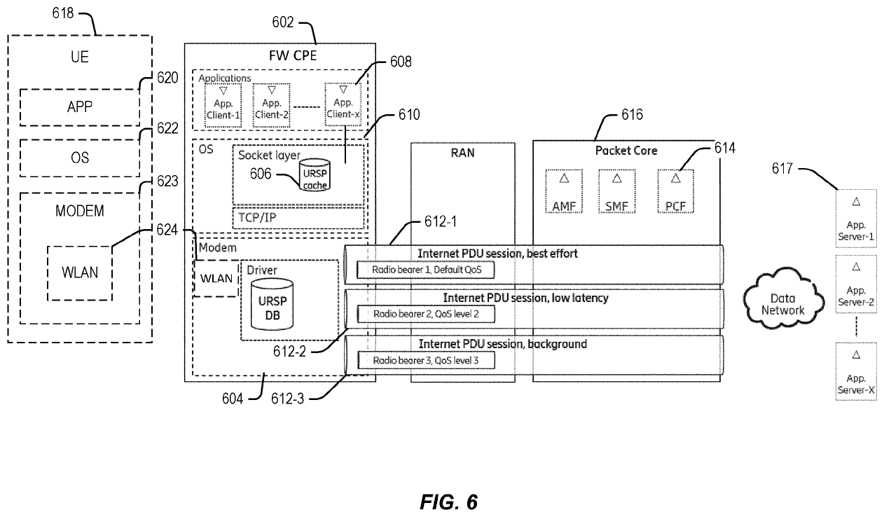

FIG. 6 illustrates an example of a URSP solution that enables granular control of application flows of with Differentiated Services Code Point (DSCP) identifiers according to some embodiments of the present disclosure.

URSP rules are sent to the modem 604 from the PCF 614 of the core network 616. In an embodiment of the present disclosure, in addition to the other traffic descriptors in the URSP rules, the URSP rules provided by the PCF 614 can include DSCP as a URSP Traffic Descriptor. A proposed update to 3GPP TS 23.503 is shown in the table below that indicates how the URSP Rules can be updated. The URSP rules can then be read into the OS URSP rule cache 606.

The URSP rules may apply both for local application clients (e.g., application client 608) and remote application clients (e.g., remote application 620 on remote UE 618). In some embodiments, the traffic can be initiated on the UE/FW CPE device 602 itself (e.g., the local application client 608 use case). In other embodiments, the traffic can initiate from the remote application 620 on remote UE 618.

In the local application case, Local application App Client 608 can request a socket and indicate also a specific DSCP value to be used for the socket. In an embodiment, the indication of the specific DSCP value for the socket may be included in the socket request, or in a later change of the socket properties, e.g., via a socket option update. The OS 610 can receive the socket request, and parse the URSP rules in the URSP rule cache 606 based on the DSCP value. The OS 610 can then request that the modem 604 create the relevant PDU session 612 for the requested DSCP value (if needed i.e., when that PDU Session is not already established). If the selected PDU Session is not already established, the modem 604 can establish a new PDU Session with the CSP so that the application client 608 or 620 can communicate with the application server 617. Note that in FIG. 6, 3 different PDU sessions, 612-1, 612-2, and 612-3 are already shown as established.

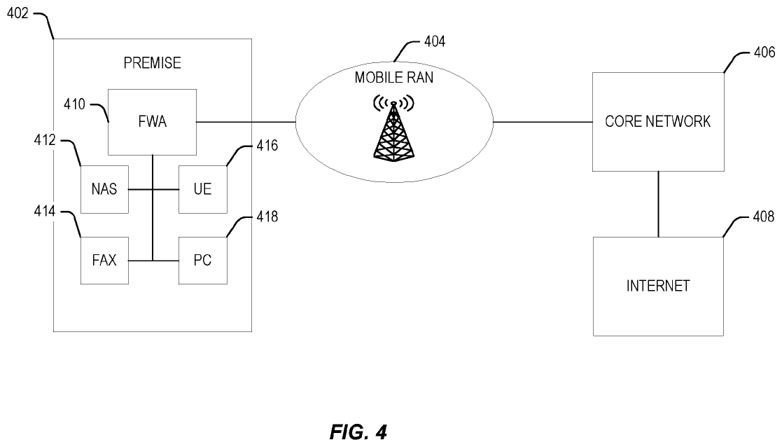

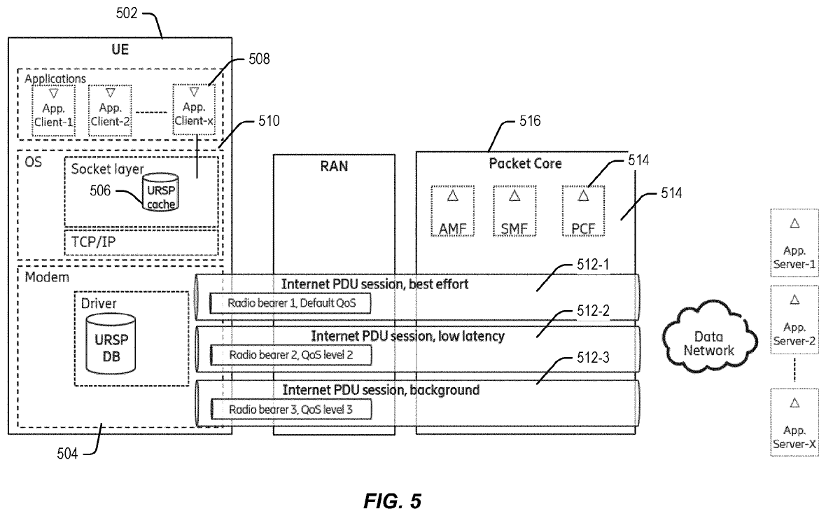

In the remote application case, the UE 618 (e.g., one of the devices 412, 414, 416, or 418 from FIG. 4) with the remote application 620 is connected to a FW CPE device 602 which acts as a router and can perform Network Address Translation (NAT) by changing the source IP address used in the network between the UE 618 and the FW CPE device 602 to an IP address of one of the PDU Sessions 612.

Remote application 620 can request a socket and also indicate a specific DSCP value to be used for the socket. In an embodiment, the indication of the specific DSCP value for the socket may be included in the socket request, or in a later change of the socket properties, e.g., via a socket option update. The DSCP value is used in the IP packets towards the UE/FW CPE device 602. The OS 622 on the UE 618 can receive the socket request from the application 620, and request modem 623 to forward the request to the FW CPE device 602 via a wired or wireless Local Area Network (WLAN 624)

The OS 610 in the UE/FW CPE device 602 parses the URSP rules in the URSP rule cache 606 based on the received DSCP value in the received IP packet.

OS 610 sends a request to the modem 604 to create the relevant PDU session for the received DSCP value (if needed i.e., when that PDU Session 612 is not already established)

Note that in FIG. 6, 3 different PDU sessions are already shown as established.

The Table below can reflect the changes to table 6.6.2.1-2 “UE Route Selection Policy Rule from TS 23.503. The underlined portions reflect the proposed addition.

TABLE 6.6.2.1-2
UE Route Selection Policy Rule

| | | | PCF permitted | |
|---|---|---|---|---|
| Information | | | to modify in a | |
| name | Description | Category | UE context | Scope |
| Rule | Determines the order the | Mandatory | Yes | UE context |
| Precedence | URSP rule is enforced in | (NOTE 1) | | |
| | the UE. | | | |
| Traffic | This part defines the Traffic | Mandatory | | |
| descriptor | descriptor components for | (NOTE 3) | | |
| | the URSP rule. | | | |
| Rule | Determines the order the | Mandatory | Yes | UE context |
| Precedence | URSP rule is enforced in | (NOTE 1) | | |
| | the UE. | | | |
| Application | It consists of OSId and | Optional | Yes | UE context |
| descriptors | OSAppId(s). (NOTE 2) | | | |
| IP | Destination IP 3 tuple(s) (IP | Optional | Yes | UE context |
| descriptors | address or IPv6 network | | | |
| (NOTE 5) | prefix, port number, | | | |
| | protocol ID of the protocol | | | |
| | above IP). | | | |
| Domain | FQDN(s) or a regular | Optional | Yes | UE context |
| descriptors | expression which are used | | | |
| | as a domain name | | | |
| | matching criteria (NOTE 6). | | | |
| Non-IP | Descriptor(s) for destination | Optional | Yes | UE context |
| descriptors | information of non-IP traffic | | | |
| (NOTE 5) | | | | |
| DNN | This is matched against the | Optional | Yes | UE context |
| | DNN information provided | | | |
| | by the application. | | | |
| Connection | This is matched against the | Optional | Yes | UE context |
| Capabilities | information provided by a | | | |
| | UE application when it | | | |
| | requests a network | | | |
| | connection with certain | | | |
| | capabilities. (NOTE 4) | | | |
| Differentiated | This is matched against the | Optional | Yes | UE context |
| Services | DSCP information provided | | | |
| Code Point | by the application. | | | |
| (DSCP) | | | | |
| List of | A list of Route Selection | Mandatory | | |
| Route | Descriptors. The | | | |
| Selection | components of a Route | | | |
| Descriptors | Selection Descriptor are | | | |
| | described in table 6.6.2.1-3. | | | |

NOTE 1:
Rules in a URSP shall have different precedence values.
2: The information is used to identify the Application(s) that is(are) running on the UE's OS. The OSId does not include an OS version number. The OSAppId does not include a version number for the application.
3: At least one of the Traffic descriptor components shall be present.
4: The format and some values of Connection Capabilities, e.g. “ims”, “mms”, “internet”, etc., are defined in TS 24.526 [19]. More than one connection capabilities value can be provided.
5: A URSP rule cannot contain the combination of the Traffic descriptor components IP descriptors and Non-IP descriptors.
6: The match of this traffic descriptor does not require successful DNS resolution of the FQDN provided by the UE Application.

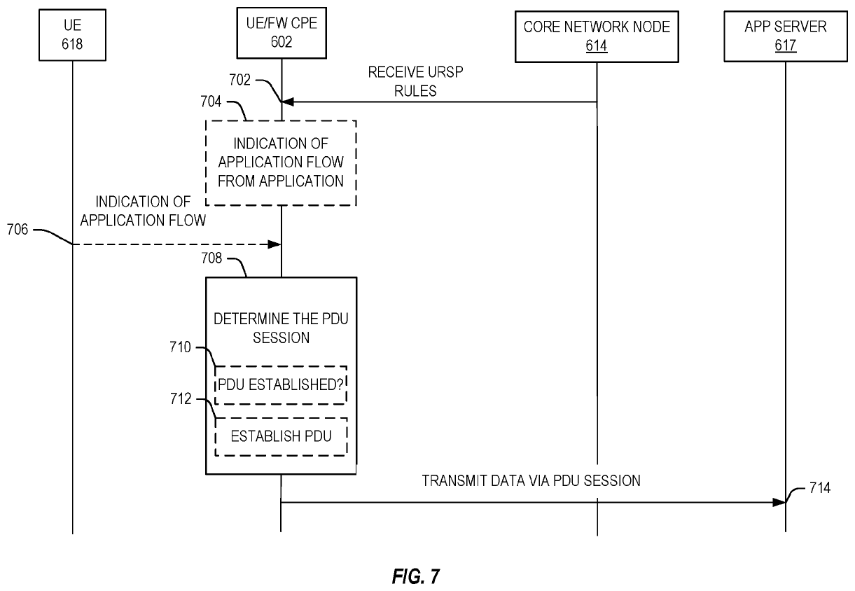

FIG. 7 illustrates a message sequence chart for a URSP solution that enables granular control of application flows of with Differentiated Services Code Point (DSCP) identifiers according to some embodiments of the present disclosure.

At 702, the UE/FW CPE 602 can receive a URSP rule that comprise DSCP values as URSP traffic descriptors from core network node 614. In an embodiment, the core network node can be PCF 614.

At 704, the UE/FW CPE 602 can optionally receive an indication of an application flow from an application (e.g., application 608). This is a local use case, where the application flow is originating from the same device as UE/FW CPE 602. In an embodiment, the indication of the new application flow is a socket request and a socket option setting of the socket request includes the DSCP value. In an embodiment, the socket request comprises the DSCP value, or a socket option setting associated with the socket request comprises the DSCP value.

At 706, the UE/FW CPE 602 can optionally receive the indication of the application flow from another UE 618 that UE/FW CPE 602 is connected to via a WLAN 624. The indication of the new application flow can be a received packet on the network connection with the UE 618, and the received packet can include the DSCP value. For example, the UE 618 (e.g., one of the devices 412, 414, 416, or 418 from FIG. 4) with the remote application 620 is connected to a FW CPE device 602 which acts as a router and can perform Network Address Translation (NAT) by changing the source IP address used in the network between the UE 618 and the FW CPE device 602 to an IP address of one of the PDU Sessions 612.

At 708, the UE/FW CPE 602 can determine a PDU Session based on the URSP rule that comprises the DSCP value from the socket request or the received packet. If the PDU session is not already established at step 710, the UE/FW CPE 602 can establish the PDU session at 712, and then bind the socket request to a source IP address of the PDU session, or via network address translation, bind the new application flow with the UE 618 to the PDU Session.

At 714, the UE/FW CPE 602 can then transmit the data associated with the application flow from the application 608 or 620 via the PDU session that is determined based on the URSP rule that comprises the DSCP value and a corresponding URSP traffic descriptor.

In an embodiment the UE/FW CPE 602 can receive another indication of a new application flow from the application, the other indication of a new application flow comprising a different DSCP value. The UE/FW CPE 602 can then determine another PDU session based on another URSP traffic descriptor corresponding to the other DSCP value and transmit other data from the other application via the other PDU session. In various embodiments, the other PDU session can be a different PDU session than the first one. In other embodiments, it can be the same PDU session. Additionally, the other application flow can originate from the same application, or from a different application, either remote or local.

In an embodiment, the PDU session corresponds to a URSP traffic category of at least one of the following URSP traffic categories a background traffic category; a default traffic category; a high bandwidth traffic category; a medium bandwidth traffic category; a bounded medium latency traffic category; or a time-critical traffic category.

FIG. 8 illustrates one example of a cellular communications system 800 in which embodiments of the present disclosure may be implemented. In the embodiments described herein, the cellular communications system 800 can be a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 802-1 and 802-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or Remote Radio Heads (RRHs), or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5GS is referred to as the 5GC. The base stations 802 (and optionally the low power nodes 806) are connected to the core network 810. The core network 810 can include a PCF 614 that can provide URSP rules to the UE 812 as described above with reference to FIG. 6.

The base stations 802 and the low power nodes 806 provide service to UEs 812-1 through 812-5 in the corresponding cells 804 and 808. The UEs 812-1 through 812-5 are generally referred to herein collectively as UEs 812 and individually as UE 812. In the following description, the UEs 812 are oftentimes UEs, but the present disclosure is not limited thereto. In an embodiment, UE 812 can be similar to and perform the functionality described with respect to UE 618 or UE/FW CPE 602 in FIGS. 6 and 7.

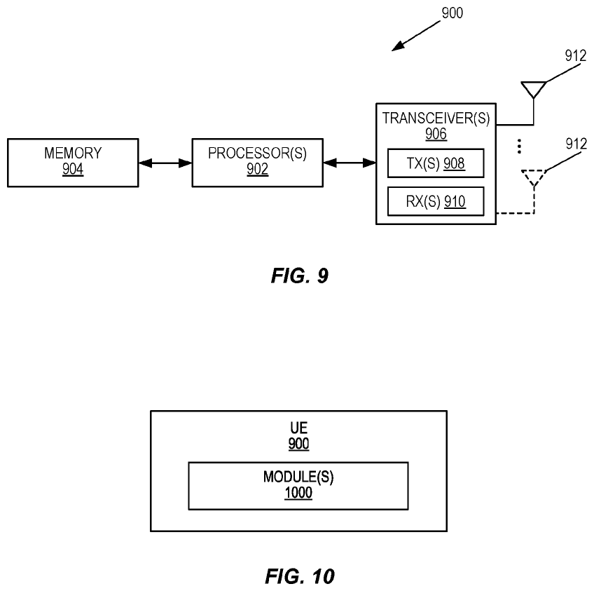

FIG. 9 is a schematic block diagram of a UE 900 according to some embodiments of the present disclosure.

As illustrated, the UE900 includes one or more processors 902 (e.g., Central Processing Units (CPUs), Application Specific Integrated Circuits (ASICs), Field Programmable Gate Arrays (FPGAs), and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by one of ordinary skill in the art. The processors 902 are also referred to herein as processing circuitry. The transceivers 906 are also referred to herein as radio circuitry. In some embodiments, the functionality of the UE 900 described above may be fully or partially implemented in software that is, e.g., stored in the memory 904 and executed by the processor(s) 902. Note that the UE 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the UE 900 and/or allowing output of information from the UE 900), a power supply (e.g., a battery and associated power circuitry), etc.

In an embodiment, UE 900 can be similar to and perform the functionality described with respect to UE 618 or UE/FW CPE 602 in FIGS. 6 and 7.

In some embodiments, a computer program including instructions which, when executed by at least one processor, causes the at least one processor to carry out the functionality of the UE 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

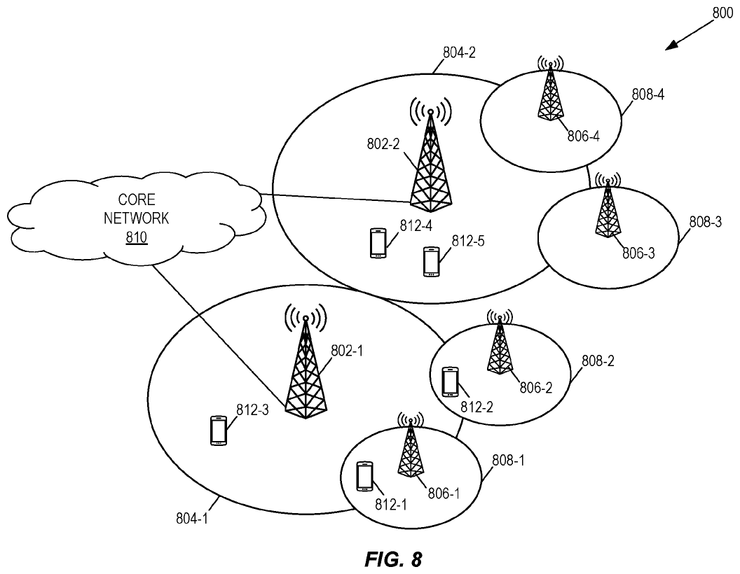

FIG. 10 is a schematic block diagram of the UE 900 according to some other embodiments of the present disclosure. The UE 900 includes one or more modules 1000, each of which is implemented in software. The module(s) 1000 provide the functionality of the UE 900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

1. A method performed by a device for enabling granular control of application flows with Differentiated Services Code Point (DSCP) identifiers with User Equipment (UE) Route Selection Policy (URSP) traffic classification, the method comprising:
receiving a URSP rule that comprise DSCP values as URSP traffic descriptors;
receiving an indication of a new application flow associated with an application, wherein the indication of the application flow comprises a DSCP value;
determining a Protocol Data Unit (PDU) session based on the URSP rule that comprises the DSCP value comprised in the indication of the new application flow; and
transmitting data for the new application flow via the PDU session that is determined based on the URSP rule that comprises the DSCP value and a corresponding URSP traffic descriptor.

2. The method of claim 1, further comprising:
determining that the PDU session is not established; and
establishing the PDU session.

3. The method of claim 1, further comprising:
receiving the URSP rule from a core network node.

4. The method of claim 1, wherein the device is a User Equipment device, and the application is a local application.

5. The method of claim 1, wherein the indication of the new application flow is a socket request.

6. The method of claim 5, wherein the socket request comprises the DSCP value, or a socket option setting associated with the socket request comprises the DSCP value.

7. The method of claim 5, wherein the socket request is bound to a source Internet Protocol, IP, address of the PDU session.

8. The method of claim 1, wherein the device is a Fixed Wireless Access (FWA) device, and the application is a remote application on a UE communicably coupled to the FWA device.

9. The method of claim 8, wherein the indication of the new application flow is a received packet on a network connection with the UE.

10. The method of claim 9, wherein the received packet comprises the DSCP value.

11. The method of claim 9, wherein the new application flow is bound to a source IP of the PDU session.

12. The method of claim 1, further comprising:
receiving another indication of a new application flow from the application, the other indication of a new application flow comprising a different DSCP value;
determining another PDU session based on another URSP traffic descriptor corresponding to the other DSCP value; and
transmitting other data from the other application via the other PDU session.

13. The method of claim 1, wherein the PDU session corresponds to a URSP traffic category of at least one of the following URSP traffic categories:
a background traffic category;
a default traffic category;
a high bandwidth traffic category;
a medium bandwidth traffic category;
a bounded medium latency traffic category; or
a time-critical traffic category.

14. A device configured for enabling granular control of application flows with Differentiated Services Code Point (DSCP) identifier with User Equipment (UE) Route Selection Policy (URSP) traffic classification, the device comprising a radio interface and processing circuitry configured to:
receive a URSP rule that comprise DSCP values as URSP traffic descriptors;
receive an indication of a new application flow associated with an application, wherein the indication of a new application flow comprises a DSCP value;
determine a Protocol Data Unit (PDU) session based on the URSP rule that comprises the DSCP value comprised in the indication of a new application flow; and
transmit data for the new application flow via the PDU session that is determined based on the URSP rule that comprises the DSCP value and a corresponding URSP traffic descriptor.

15. The device of claim 14, wherein the processing circuitry is further configured to:
determine that the PDU session is not established; and
establish the PDU session.

16. The device of claim 14, wherein the processing circuitry is further configured to:
receive the URSP rule from a core network node.

17. The device of claim 14, wherein the device is a User Equipment device, and the application is a local application.

18. The device of claim 14, wherein the indication of the new application flow is a socket request.

19. The device of claim 18, wherein the socket request comprises the DSCP value, or a socket option setting associated with the socket request comprises the DSCP value.

20-26. (canceled)

27. A non-transitory computer-readable medium comprising instructions stored thereon, that when implemented by a processor perform operations for enabling granular control of application flows with Differentiated Services Code Point (DSCP) identifiers with User Equipment (UE) Route Selection Policy (URSP) traffic classification, the operations comprising:
receiving a URSP rule that comprise DSCP values as URSP traffic descriptors;
receiving an indication of a new application flow associated with an application, wherein the indication of a new application flow comprises a DSCP value;
determining a Protocol Data Unit (PDU) session based on the URSP rule that comprises the DSCP value comprised in the indication of a new application flow; and
transmitting data for the new application flow via the PDU session that is determined based on the URSP rule that comprises the DSCP value and a corresponding URSP traffic descriptor.
